(19) United States
(12) Patent Application Publication
(10) Pub. No.: US 2006/0033715 A1
(43) Pub. Date: Feb. 16, 2006

(54) Wheel type mechanical instruction switch

(76) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(21) Appl. No.: 10/917,387

(22) Filed: Aug. 13, 2004

(51) Int. Cl. G09G 5/08

(52) U.S. Cl. 345/163

(57) ABSTRACT

A wheel type mechanical instruction switch employs a simple mechanical contact leg structure to replace conventional button switches to output instructions. The invention has a wheel coupling with a contact leg which is moveable to the left side and the right side with the movement of the wheel to form a selected displacement, and a conductive leg located respectively within the left and right displacement. When a force sways the wheel, the contact leg is moved to connect to the conductive leg to generate an instruction signal. The structure is easy to fabricate at a lower cost.

### FIELD OF THE INVENTION

The present invention relates to a wheel type mechanical instruction switch and particularly to a wheel type mechanical switch adopted for use on electronic devices such as mouses, remote control devices or keyboards to output different instruction signals.

### BACKGROUND OF THE INVENTION

In the scroll mouse now being commonly used, there is a wheel located between the left and the right function keys to enable users to directly skip pages or text lines through rotation of the wheel when reading lengthy texts (such as novels or presentation data) without depressing the page down key or moving the mouse and cursor to the scroll spots on the right side of the screen to execute page down or skip line operation. Namely, the wheel can replace the scroll function on the right side of the screen to make user operation easier. In R.O.C. patent No. 590292, applicant proposes an improved mouse design. It aims to provide an improved scroll function that has a scroll design on the lower side of the screen to provide leftward and rightward transverse movements in addition to the up and down longitudinal movements provided by the scroll on the right side of the screen. It is applicable to table listing software such as EXCEL or ACCESS or Web pages. However, for lengthy table fields, scroll operation and control cannot fully meet requirements, and the general keyboard does not have corresponding keys to provide transverse movement function. Users have to move the mouse to the scroll spots and depress the left key to operate. Such a design does not fully exploit the advantages of the wheel. Therefore the present invention aims to provide a design that directly uses the wheel of the mouse, and the left and right keys, and left and right direction keys to output switch ON/OFF signals to move the mouse cursor to a desired location for execution or viewing without moving the mouse (referring to FIG. 2)

FIG. 1 shows another conventional design disclosed by Microsoft Co. It is a mouse equipped with a tilt wheel (details can be found in U.S. Pat. No. 6,700,564. The actual product includes a sway seat which makes design more complicated). It has a wheel coupled with a sway seat. The sway seat may be moved with the wheel to the left and right side to touch button switches located on two sides of the sway seat to output corresponding instructions. Adding the sway seat makes design and fabrication more complicated. And the size of the mouse cannot be shrunk because of addition of the sway seat and the button switches. It is only suitable for large mouse products.

Based on the second cited reference mentioned above, it is clear that the industry at present still mainly focuses on the button switches to generate output signals. The button switch is more expensive. Moreover, with the prevailing product trend that requests lean and light, adding the button switch is against this trend in terms of the mouse size. Hence at present only the medium and large mouses adopt such a design. It also cannot be adapted to the keyboard or remote control device that also has a wheel. Because the location to accommodate the wheel is even more constrained on the keyboard and remote control device. Therefore to develop a small size, low cost and easy to fabricate wheel and instruction switch is one of the main design focuses in the industry.

### SUMMARY OF THE INVENTION

Therefore the primary object of the present invention is to resolve the aforesaid disadvantages. The present invention aims to provide a simple mechanical type conductive contact leg to generate instruction output to replace the conventional button switches. The instruction switch according to the invention includes a wheel and a contact leg driven by the wheel to move to the left or right, and conductive legs located within the left and right moving range of the contact leg so that when the wheel is swayed by forces, the contact leg connects to the conductive leg to generate instruction signals. The structure is simpler and may be fabricated at a lower cost.

Another object of the invention is to provide a depressing displacement under the contact leg formed by a downward movement of the wheel. And a base board is provided to electrically connect to a top contact leg located within the depressing displacement to generate another instruction signal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional design for a mouse.

FIG. 2 is a perspective view of another conventional design for a mouse.

FIG. 3 is a perspective view of the present invention.

FIG. 4 is an exploded view of the present invention.

FIGS. 5A, 5B and 5C are schematic views of the present invention in sway conditions of moving to the left side and the right side.

FIGS. 6A and 6B are schematic views of the invention in depressing conditions.

FIG. 7 is a schematic view of an embodiment of the invention adopted on a mouse.

FIG. 8 is a schematic view of an embodiment of the invention adopted on a keyboard.

FIG. 9 is a schematic view of an embodiment of the invention adopted on a remote control device.

### DETAILED DESCRIPTION OF THE PREFERRED EMBODIMENTS

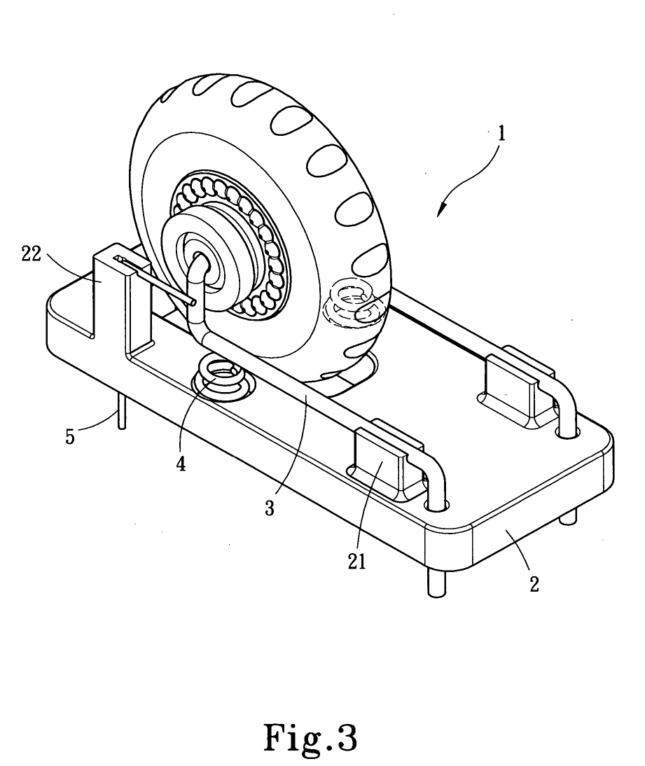

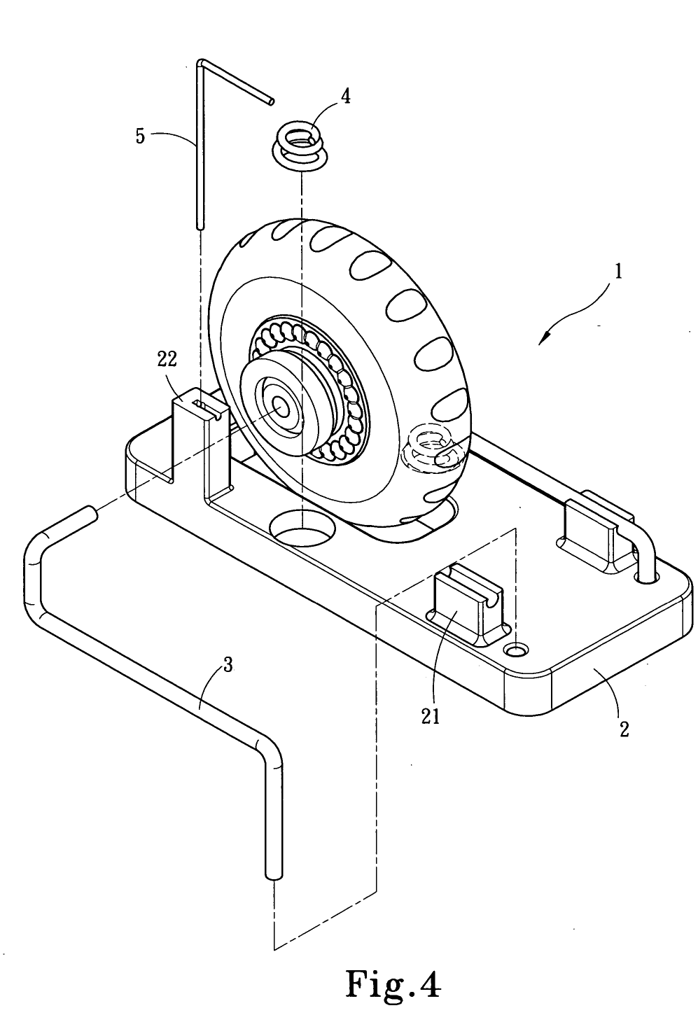

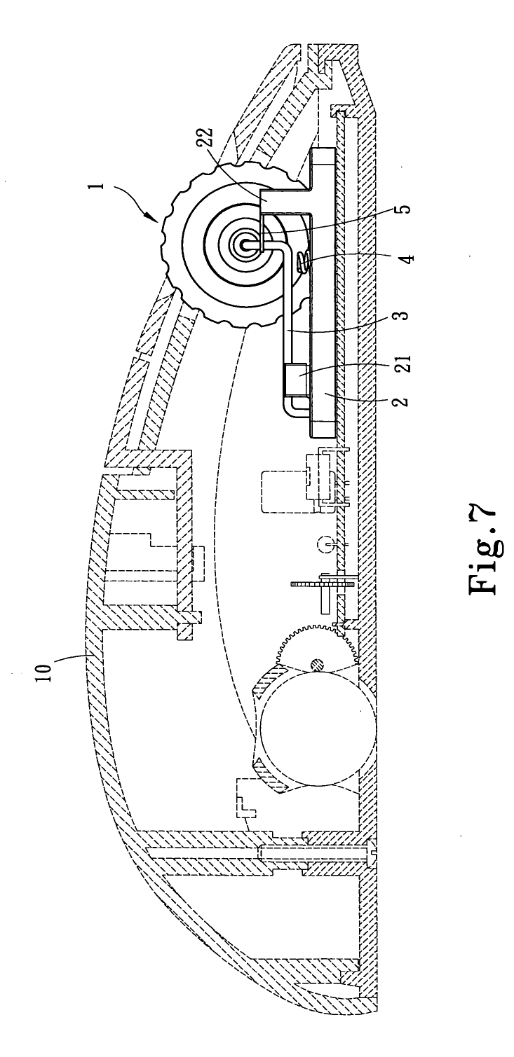

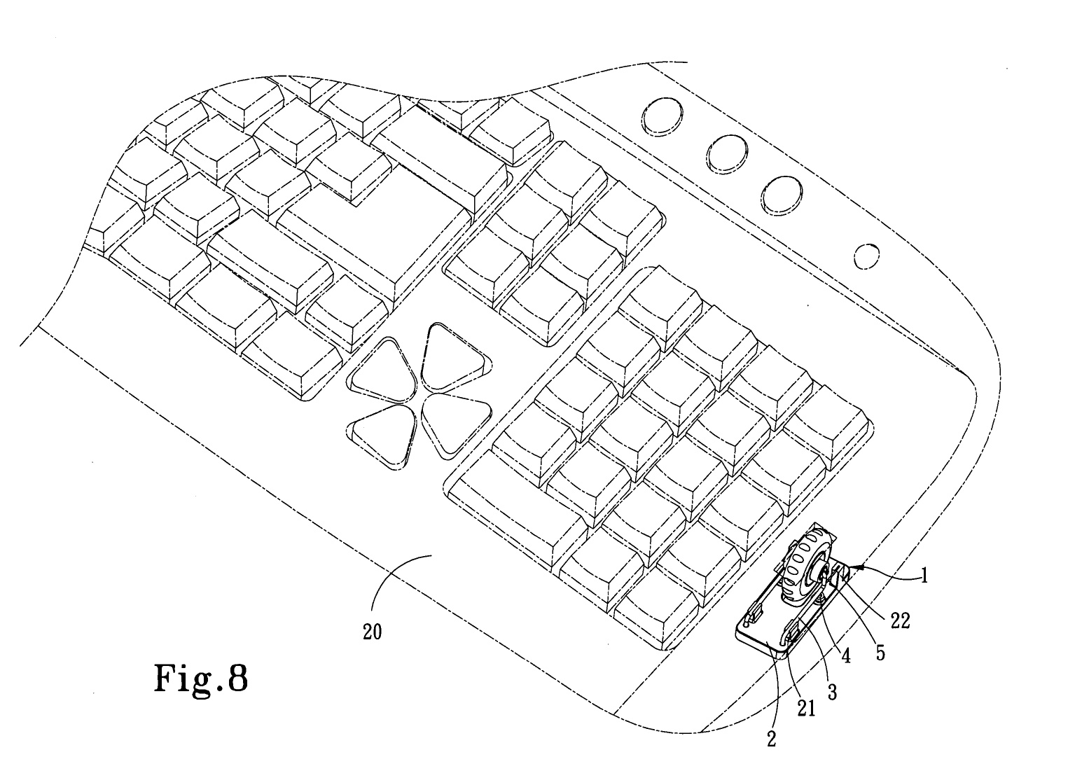

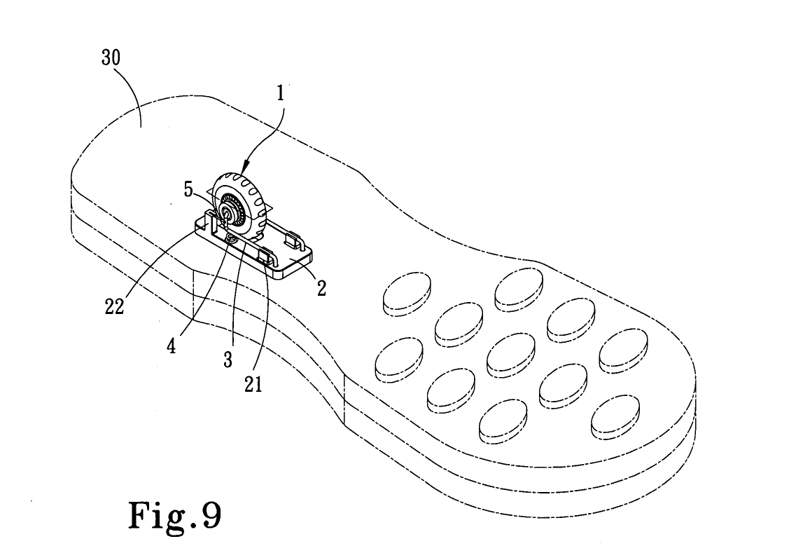

Please referring to FIGS. 3 and 4, the wheel type mechanical instruction switch according to the present invention is adopted for use on electronic products such as a mouse 10 (referring to FIG. 7), a keyboard 20 (referring to FIG. 8) or a remote control device 30 (referring to FIG. 9) to output different instruction signals. It includes a wheel 1 and a base board 2 corresponding to sway movements of the wheel 1 to generate instruction signals.

The mechanical instruction switch according, to the invention, in addition to the wheel 1 and the base board 2, also includes a contact leg 3 which has one end fastened to the base board 2 and other end coupled to the wheel 1 and driven by the wheel 1 to move to the left side or the right side for a selected displacement (the left and right side displacements may be formed by transverse movements or sway movements. In the embodiment discussed below, the sway movement is adopted as an example). The other end of the contact leg 3 coupled on the wheel 1 runs through the wheel 1 to form an axle thereof. The base board 2 has a first bracing member 21 mounted thereon to anchor the contact leg 3 and brace the wheel 1. Moreover, the contact leg 3 has a depressing displacement thereunder formed by a downward movement of the wheel 1. The base board 2 further is electrically connected to a top contact leg 4 located in the depressing displacement to generate another instruction signal. The top contact leg 4 is bent and elastic. The mechanical instruction switch of the invention further has a conductive leg 5 which has one end coupled on the base board 2 and other end located within the left and the right displacement of the contact leg 3. The base board 2 further has a second bracing member 22 to anchor the conductive leg 5. The contact leg 3 and the conductive leg 5 are located on one side or two sides of the wheel 1 (the base board 2 may also be a simple support board and a circuit board with an instruction signal circuit may be located beneath the base board 2).

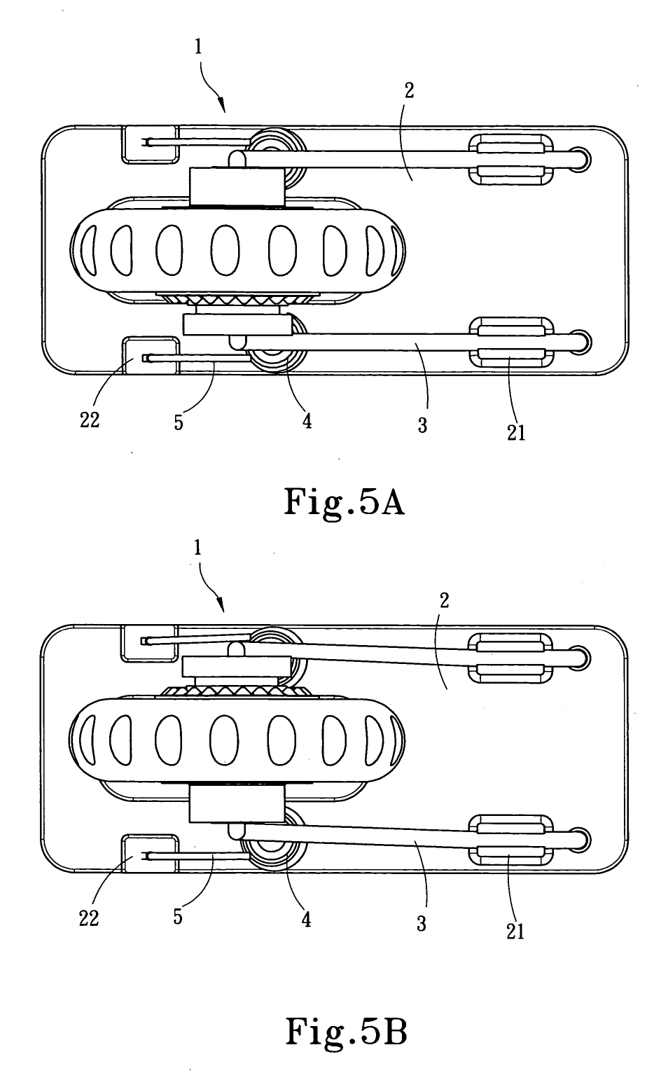

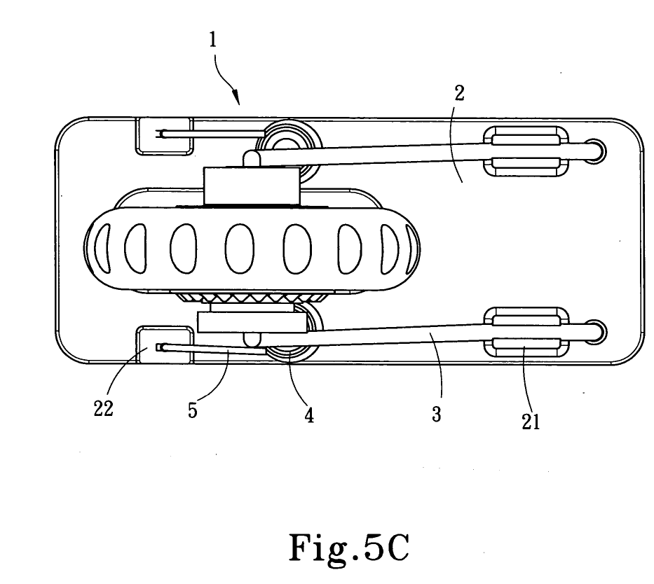

Refer to FIGS. 5A, 5B and 5C for the invention in the sway movement conditions. When a user exerts a force on the wheel 1 to sway the wheel 1 to the left side or right side, as the wheel 1 is coupled on the contact leg 3, the contact leg 3 is driven by the wheel 1 to sway at the same time to touch the conductive leg 5 within the sway displacement to generate an instruction signal. When the force is released from the wheel 1, the flexibility of the contact leg 3 sways itself and the wheel 1 back to their original positions.

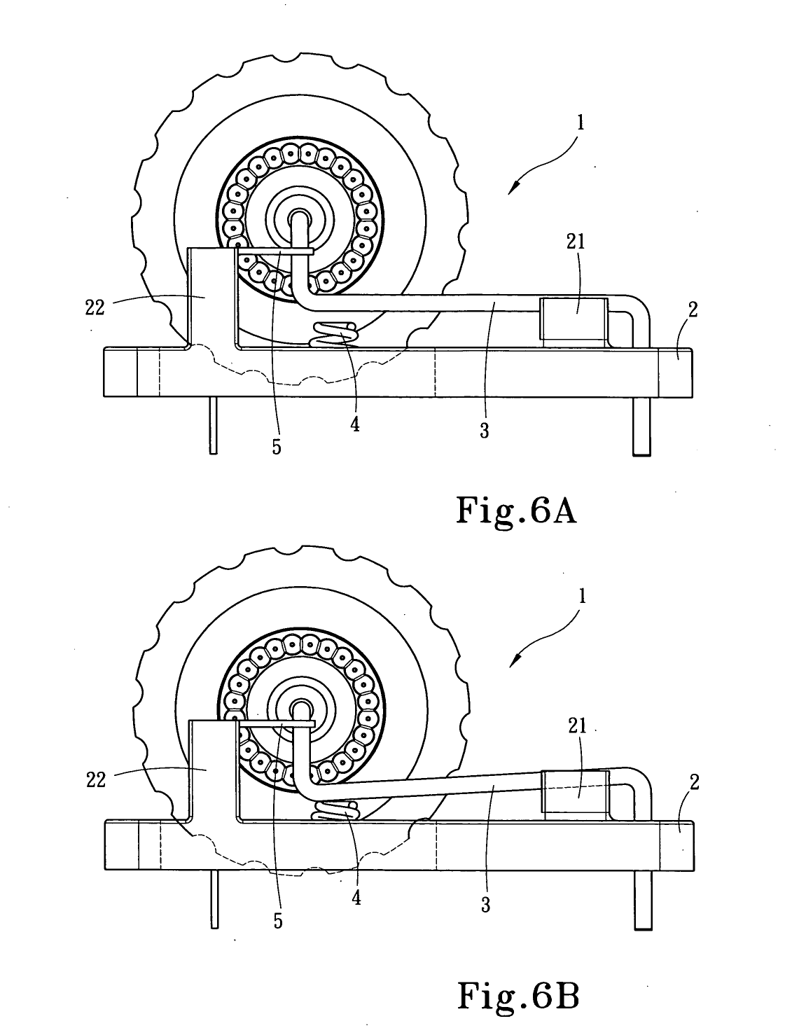

Refer to FIGS. 6A and 6B for the invention in a depressing condition. When a user exerts a force on the wheel 1 downward, the contact leg 3 is driven by the wheel 1 to move downwards at the same time to touch the top contact leg 4 within the depressing displacement to generate another instruction signal. When the force is released from the wheel 1, the flexibility of the contact leg 3 bounces the contact leg 3 and the wheel 1 back to their original positions. To take into account of the depressing force is greater than the bouncing flexible force of the contact leg 3, and the wheel 1 could be not able to return to its original position, the top contact leg 4 is bent to become elastic to store the elastic force when subject to the downward movement so that the elastic force may be released during the bouncing back movement to move the wheel 1 and the contact leg 3 back to their original positions.

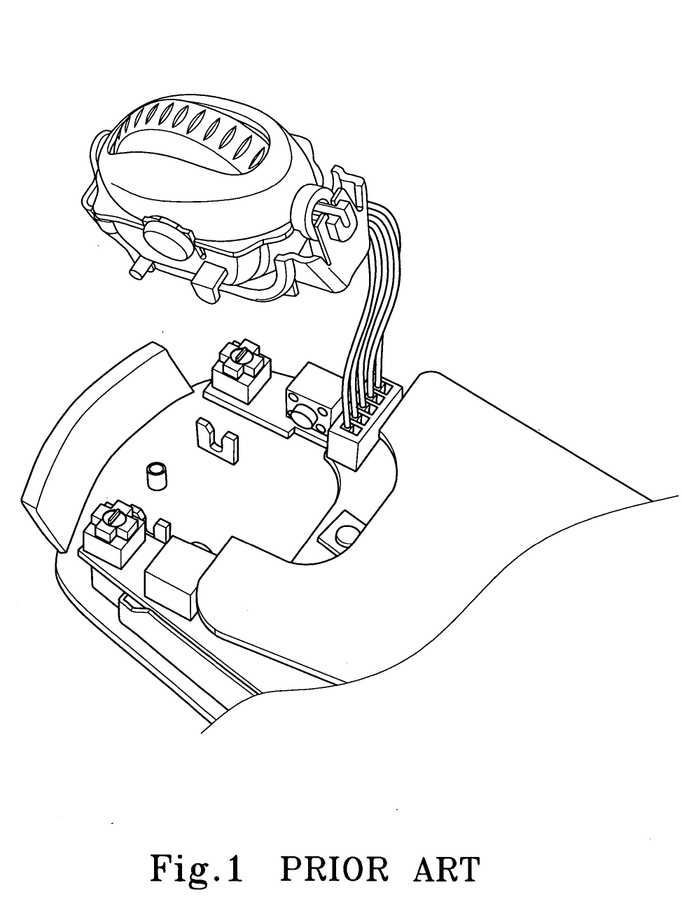

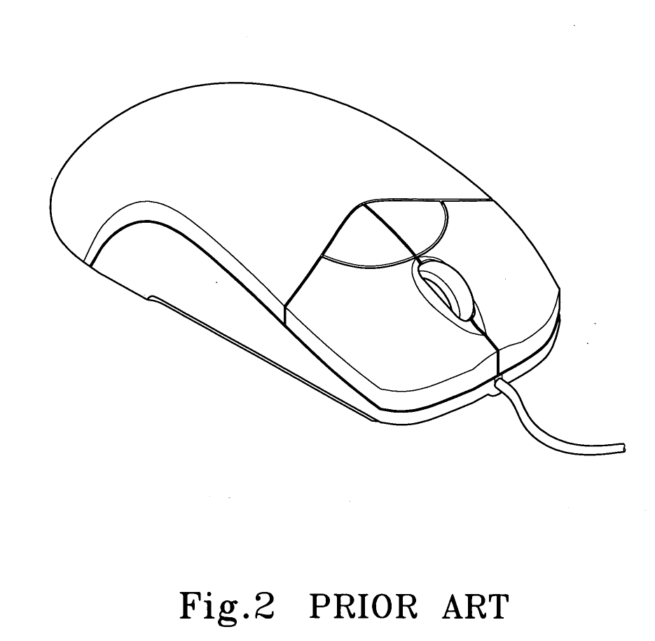

By means of the construction set forth above, the invention does not require the complicated sway seat shown in FIG. 1. Moreover, the contact leg design of the invention can replace the button switches located on the left side and the right side of the wheel and under the wheel. The design is simpler and can reduce fabrication cost. It also is more compact than the conventional design that adopts the sway seat and button switches. Therefore the invention may be adapted to a wide range of electronic products such as mouses, keyboards and the like.

What is claimed is:

1. A wheel type mechanical instruction switch located between a wheel and a base board to generate instruction signals corresponding to sway movements of the wheel, comprising:
a contact leg which has one end fastened to the base board and other end coupled on the wheel moveable with the wheel to a left side and a right side for a selected displacement; and
a conductive leg which has one end coupled on the base board and other end located within the displacement of the left side and the right side of the contact leg to connect the contact leg when the wheel is swayed by a force to generate an instruction signal.

2. The wheel type mechanical instruction switch of claim 1, wherein the contact leg and the conductive leg are located on one side of the wheel.

3. The wheel type mechanical instruction switch of claim 1, wherein the contact leg and the conductive leg are located on two sides of the wheel.

4. The wheel type mechanical instruction switch of claim 1, wherein the contact leg further has a depressing displacement thereunder formed by a downward movement of the wheel, the base board being electrically coupled to a top contact leg which is located within the depressing displacement to generate another instruction signal.

5. The wheel type mechanical instruction switch of claim 4, wherein the top contact leg is bent and elastic.

6. The wheel type mechanical instruction switch of claim 1, wherein the other end of the contact leg runs through the wheel to form an axle of the wheel.

7. The wheel type mechanical instruction switch of claim 1, wherein the base board has a first bracing member to anchor the contact leg.

8. The wheel type mechanical instruction switch of claim 1, wherein the base board has a second bracing member to anchor the conductive leg.
